(19) United States
(12) Patent Application Publication
(10) Pub. No.: US 2010/0277947 A1
(43) Pub. Date: Nov. 4, 2010

(54) Light Source Device and Display Device

(75) Inventor: Yasunari Nagata, Kirishima-shi (JP)

Correspondence Address: Hogan Lovells US LLP, 1999 AVENUE OF THE STARS, SUITE 1400, LOS ANGELES, CA, 90067, US

(73) Assignee: KYOCERA CORPORATION, Kyoto-shi, Kyoto (JP)

(21) Appl. No.: 12/810,136

(22) PCT Filed: Dec. 22, 2008
(86) PCT No.: PCT/JP2008/073346

§ 371 Date: Jun. 22, 2010

(30) Foreign Application Priority Data
Dec. 27, 2007 (JP) 2007-335580

(51) Int. Cl. F21V 7/22

(52) U.S. Cl. 362/606

(57) ABSTRACT

A light guide body of a light source device includes a first portion where a low intensity distribution area of one light source and another low intensity distribution area of another light source overlap each other, a second portion positioned closer to the one light source than a boundary line connecting boundaries, each of the boundaries being between the first portion and an overlapping portion where a high intensity distribution area of the one light source overlaps with high intensity distribution areas of the light sources, and a third portion other than the second portion. The prism includes a first prism pattern in which a component reflecting the light in the second portion to a side of the first portion is larger than a component reflecting the light in the second portion to a side of the third portion.

### TECHNICAL FIELD

The invention relates to a light source device and a display device that guide light incident from a plurality of light sources to a target location through a light guide body and irradiate the target location with the light.

### BACKGROUND ART

Examples of light source devices include light source devices that emit light, which is incident on a light guide plate from a light source such as a cold cathode fluorescent lamp (CCFL) that is a line light source or an light emitting diode (LED) that is a point light source, through a major surface of the light guide plate, such as backlights of liquid crystal display devices.

However, in the light source devices configured as described above, in a case where a plurality of line light sources are disposed to increase the size or where a plurality of point light sources are disposed even for a small size device, there exists non-light-emitting portions between the light sources. Due to this, in the vicinity of light entrance portions of the light guide plate on which the light is incident from the light sources, nonuniformity of luminance tends to increase. Accordingly, technologies for preventing the nonuniformity of the luminance from increasing are developed and disclosed in Patent Documents 1 and 2, for example.

[Patent Document 1] Japanese Patent Application Laid-open No. H09-259623

[Patent Document 2]Japanese Patent Application Laid-open No. 2001-110224

### DISCLOSURE OF INVENTION

### Problems to be Solved by the Invention

However, in an LED light source backlight module that is disclosed in Patent Document 1, an area for forming a concave light introduction portion and a reflection surface has to be secured in a light guide plate around a portion where a light source is mounted. Accordingly, the area cannot be used as a display area. Similarly, in a surface light emitting device that is disclosed in Patent Document 2, an area for forming a shaping portion formed integrally with a light guide plate has to be secured. Accordingly, the area cannot be used as a display area. That is, according to the technologies disclosed in Patent Documents 1 and 2, a dead space is large and thus, it is difficult to decrease the device size.

The invention has been made in view of the above circumferences, and an object thereof is to provide a light source device and a display device capable of preventing increase in nonuniformity of luminance due to the existence of non-light-emitting portions between a plurality of light sources and capable of decreasing a device size.

### Means for Solving Problem

A light source device according to a first aspect of the invention is provided with a plurality of light sources, a light guide body disposed to face the light sources, and a prism to reflect light from the light guide body. In the light guide body, an area where light having luminance equal to or higher than a reference value is incident from each of the light sources is defined as a high intensity distribution area, and an area where light having luminance lower than the reference value is incident is defined as a low intensity distribution area. The light guide body includes a first portion, a second portion, and a third portion. The first portion is a portion where a low intensity distribution area defined by one of the light sources and another low intensity distribution area defined by another one of the light sources adjacent to the one of the light sources overlap each other. The second portion is a portion of the high intensity distribution area. The second portion is positioned closer to the one of the light sources than a boundary line connecting boundaries. Each of the boundaries is between the first portion and an overlapping portion where a high intensity distribution area defined by the one of the light sources overlaps with high intensity distribution areas defined by the light sources adjacent to the one of the light sources. The third portion is a portion of the high intensity distribution areas other than the second portion. The prism comprises a first prism pattern in which a component reflecting the light in the second portion to a side of the first portion is larger than a component reflecting the light in the second portion to a side of the third portion.

A light source device according to a second aspect of the invention, comprises: a light source; a light guide plate that includes a first major surface, a second major surface, and a facing surface facing the light source, and emits light from the light source by the first major surface; and a prism that is positioned at a side of the second major surface of the light guide plate, and reflect light incident on the light guide plate. The prism has a first structure body that is positioned in a front area of the light source in plan view. The first structure body has a length in a direction orthogonal to the facing surface larger than a length in a direction parallel to the facing surface.

A display device according to the present invention comprises the aforementioned light source device according to the invention.

### EFFECT OF THE INVENTION

The light source device according to a first aspect of the invention comprises the prism having the first prism pattern in which a component reflecting light in the second portion to the side of the first portion is larger than a component reflecting light in the second portion to the side of the third portion. In the light source device according to a second aspect of the invention, the first structure body having an elliptical shape or a rectangular shape in plan view is disposed such that the longitudinal direction thereof is extended along a direction substantially vertical to the surface of the light guide body facing the light sources corresponding to the light sources. That is, in the light source device, the light of the high intensity distribution areas with relatively high luminance can be distributed to the low intensity distribution areas with relatively low luminance. For this reason, in the light source device, the luminance in the low intensity distribution areas can be increased while the luminance in the high intensity distribution areas can be prevented from excessively increasing. Accordingly, in the light source device, nonuniformity of the luminance due to existence of the non-light-emitting portions between the light sources can be prevented from increasing. In addition, the light source device can use the areas of the second portions corresponding to the high intensity distribution areas and the first portions corresponding to the low intensity distribution areas as the display area. Therefore, even in the configuration where the light emitted from the light sources is made to be incident on the light guide body, undesirable dead spaces can be prevented from being generated, and thus a device size can be decreased.

### BRIEF DESCRIPTION OF THE DRAWINGS

FIG. 1A is a plan view illustrating a schematic configuration of a light source device according to a first embodiment of the invention.

FIG. 1B is a cross-sectional view taken along the line Ib-Ib of FIG. 1A.

FIG. 2 is a graph illustrating an example of a relationship between an intensity distribution angle and luminance of a light source in the light source device.

FIG. 3A is a plan view illustrating the schematic configuration of a plurality of light sources and a light guide body.

FIG. 3B is a plan view enlarging and illustrating essential portions of the light sources and the light guide body.

FIG. 4A is a plan view illustrating a schematic configuration of a light source device according to a second embodiment of the invention.

FIG. 4B is a cross-sectional view taken along the line IVb-IVb of FIG. 4A.

FIG. 5A is a plan view illustrating a schematic configuration of the light sources and a light guide body.

FIG. 5B is a plan view enlargedly illustrating essential portions of the light sources and the light guide body.

FIG. 6A is a plan view illustrating a schematic configuration of a light source device according to a third embodiment of the invention.

FIG. 6B is a cross-sectional view taken along the line VIb-VIb of FIG. 6A.

FIG. 7A is a plan view illustrating a schematic configuration of light sources and a light guide body.

FIG. 7B is a plan view enlargedly illustrating essential portions of the light sources and the light guide body.

FIG. 8 is a cross-sectional view illustrating a schematic configuration of a display device provided with the light source device.

FIG. 9 is a perspective view illustrating a schematic configuration of a liquid crystal display panel of the display device.

FIG. 10 is a cross-sectional view enlarging and illustrating essential portions of the liquid crystal display panel.

### EXPLANATION OF LETTERS OR NUMERALS

X1, X2, X3 Light source device
Y Display device
BL Boundary line
10 Light source
11 Non-light-emitting portion
20 Light guide body
21 First portion
22 Second portion
23 Third portion
30 Prism
31 First prism pattern
32 Second prism pattern
33 Third prism pattern
40 Reflection body
50 Diffusion body
60 Prism
70 Liquid crystal panel
80 Casing

### BEST MODE(S) FOR CARRYING OUT THE INVENTION

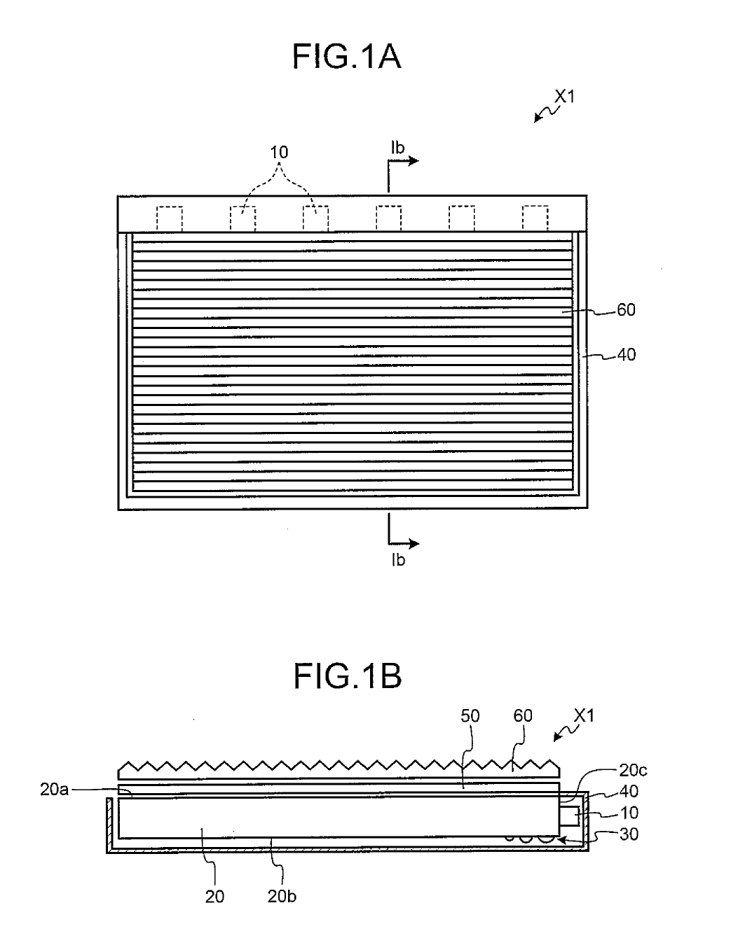

FIG. 1A is a plan view illustrating a schematic configuration of a light source device X1 according to a first embodiment of the invention and FIG. 13 is a cross-sectional view taken along the line Ib-Ib of FIG. 1A.

The light source device X1 includes a plurality of light sources 10, a light guide body 20, prism 30, a reflection body 40, a diffusion body 50, and a prism 60, and configured to guide light emitted from the light sources 10 onto an irradiation target (for example, liquid crystal display panel) through the light guide body 20.

The light sources 10 are disposed to face the light guide body 20, such that non-light-emitting portions 11 exist between the light sources 10. Here, the non-light-emitting portions 11 represent portions between the light sources 10 when the light sources 10 are disposed to be away from each other, or portions of lead terminals that are positioned at ends of a fluorescent tube. The light sources 10 include, for example, a light emitting diode (LED), a cathode fluorescent lamp (CFL), a halogen lamp, a xenon lamp, and electro-luminescence (EL), but among them, the LED is preferable in terms of reduced power consumption and reduced noise.

The light guide body 20 performs a function of guiding light incident from the light sources 10 to an irradiation target. An area on which light having luminance of a reference value or higher is incident from each of the light sources 10 is defined as a high intensity distribution area, and an area on which light having luminance lower than the reference value is incident from each of the light sources is defined as a low intensity distribution area. The reference value may be set to a desired value corresponding to required performance, but is preferably set such that luminance of a light irradiation surface 20a with respect to an irradiation target becomes substantially uniform. For example, assuming that a luminance of light that is incident in a direction vertical to a light incident surface of the light guide body 20 to which the light is incident from each of the light sources 10 is set to 1, the reference value may be set to 0.5.

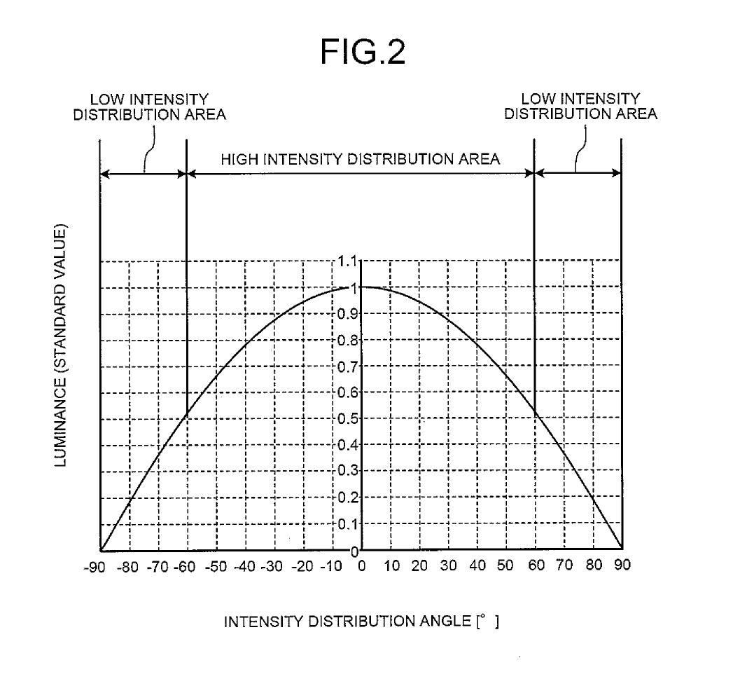

FIG. 2 is a graph illustrating an example of a relationship between an intensity distribution angle and luminance of the light source 10. If the light source 10 having the relationship illustrated in FIG. 2 is adopted, the high intensity distribution area of the light source 10 is in a range of an intensity distribution angle from −60° to 60°, and an intensity distribution angle of the low intensity distribution area of the light source 10 is in a range of an intensity distribution angle from −90° to −60° and 60° to 90°.

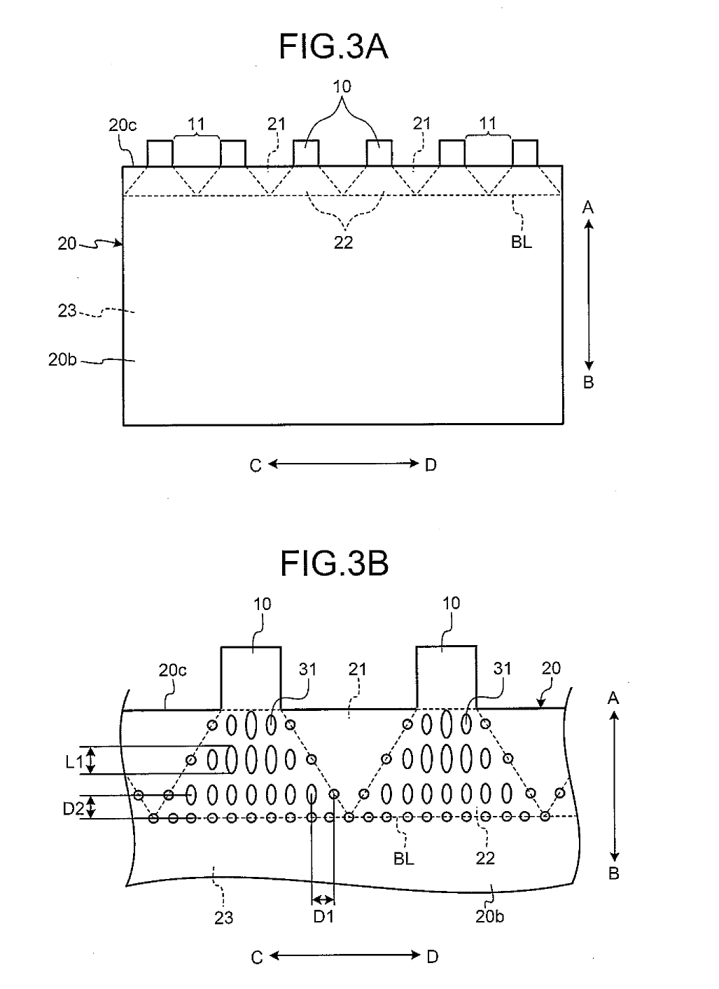

FIG. 3A is a plan view illustrating the schematic configuration of the light sources 10, the light guide body 20, and the prism 30. FIG. 3B is a plan view enlarging and illustrating essential portions of the light sources and the light guide body. The light guide body 20 is configured to include first portions 21, second portions 22, and a third portion 23, and boundaries of the respective portions 21, 22, and 23 are illustrated by broken lines in FIGS. 3A and 3B. Each of the first portions 21 is a portion where a low intensity distribution area defined by one light source 10 among the light sources 10 and a low intensity distribution area defined by another light source 10 adjacent to the one light source 10 overlap each other.

Each of the second portions 22 is a portion of the high light distribution areas of the light sources 10, and positioned at a side of the one light source 10 (a side directed by an arrow A) with respect to a boundary line BL connecting boundaries. Each of the boundaries is between one of the first portions 21 and an overlapping portion of the high intensity distribution area defined by the one light source 10 and the high intensity distribution area defined by the another light source 10 adjacent to the one light source 10. The third portion 23 is a portion, which is other than the second portions 22, of the high intensity distribution areas defined by the light sources 10. As a material of the light guide body 20, a transparent resin, such as an acrylic resin and a polycarbonate resin, may be exemplified.

The prism 30 performs a function of refracting and reflecting the incident light, and includes a first prism pattern 31. In this embodiment, the prism 30 is configured integrally with the light guide body 20.

The first prism pattern 31 is configured such that a component reflecting the light in the second portions 22 to the side of the first portions 21 is larger than a component reflecting the light in the second portions 22 to the side of the third portion 23. The first prism pattern 31 is positioned at the side of a bottom surface 20b of the light guide body 20 in the second portions 22. The first prism pattern 31 is configured to include a plurality of structure bodies each having an elliptical shape in plan view, which extends along a direction substantially vertical to a facing surface 20c of the light guide body 20 facing the light sources 10 (direction represented by an arrow AB). In the first prism pattern 31, the length L1 of the structure bodies each having an elliptical shape in plan view in a long axis direction is reduced so that the difference between a component reflecting the light in the second portions 22 to the side of the first portions 21 (in a direction of an arrow CD) and a component reflecting the light in the second portions 22 to the side of the third portion 23 (in a direction of an arrow B) decreases as the distance D1 (one example is illustrated in FIG. 3B) to the first portions 21 decreases. In the first prism pattern 31, the length L1 of the structure bodies each having an elliptical shape in plan view in a long axis direction is reduced so that the difference between the component reflecting the light in the second portions 22 to the side of the first portions 21 (in a direction of the arrow CD) and the component reflecting the light in the second portions 22 to the side of the third portion 23 (in a direction of the arrow B) decreases as the distance D2 (one example is illustrated in FIG. 3B) to the third portion 23 decreases.

The reflection body 40 performs a function of reflecting light emitted through the portion other than the light irradiation surface 20a of the light guide body 20 to the light guide body 20, and is disposed to mainly face the bottom surface 20a of the light guide body 20. The reflection body 40 also performs a function of reflecting light that is not incident on the light guide body 20 among the light emitted from the light sources 10 to the light guide body 20, and a portion of the reflection body 40 covers a portion of the light sources 10. As a material of the reflection body 40, for example, white foam that is obtained by extending a polyethylene terephthalate (PET) material, a material that is obtained by forming a silver film on a base containing the PET material, and a material that is obtained by laminating a dielectric film on the base containing the PET material may be exemplified.

The diffusion body 50 performs a function of equalizing luminance of light emitted from the light irradiation surface 20a of the light guide body 20 to the irradiation target, and is disposed to mainly face the light irradiation surface 20a of the light guide body 20. As a material of the diffusion body 50, a sheet that is obtained by hardening a resin containing silica beads on a base containing a PET material and a sheet that is obtained by mixing silica beads with a polycarbonate (PC) material may be exemplified.

The prism 60 performs a function of refracting incident light, and is configured to refract light incident on the prism 60 so that the incident light is made in a direction substantially vertical to the light irradiation surface 20a of the light guide body 20 and emitted.

In the light source device X1 according to this embodiment, the prism 30 has the first prism pattern 31. That is, in the light source device X1, light in high intensity distribution areas with relatively high luminance can be distributed to low intensity distribution areas with relatively low luminance. For this reason, in the light source device X1, it is possible to increase the luminance in the low intensity distribution areas while preventing the luminance in the high intensity distribution areas from excessively increasing. Accordingly, in the light source device X1, nonuniformity in the luminance due to existence of the non-light-emitting portions 11 between the light sources 10 can be prevented from increasing. In addition, the light source device X1 can use the second portions 22 and the third portion 23 as a display area. Therefore, even in the configuration where the light emitted from the light sources 10 is made to be incident on the light guide body 20, undesirable dead spaces can be prevented from being generated, and thus a device size can be decreased.

In the light source device X1, the first prism pattern 31 is configured such that the difference between the component reflecting the light in the second portions 22 to the side of the first portions 21 and the component reflecting the light in the second portions 22 to the side of the third portion 23 decreases as the distance D1 to the first portions 21 decreases. Therefore, in the light source device X1, the boundary between the first portions 21 and the second portions 22 can be hardly viewed.

In the light source device X1, the first prism pattern 31 is configured such that the difference between the component reflecting the light in the second portions 22 to the side of the first portions 21 and the component reflecting the light in the second portions 22 to the side of the third portion 23 decreases as the distance D2 to the third portion 23 decreases. Therefore, in the light source device X1, the boundary between the second portions 22 and the third portion 23 can be hardly viewed.

In the light source device X1, the first prism pattern 31 is configured to include the structure bodies each having an elliptical shape in plan view, which extends along the direction (direction of the arrow AB) substantially vertical to the facing surface 20c of the light guide body 20 facing the light sources 10. Therefore, in the light source device X1, a mold and a stamper disposed in the mold can be manufactured using photolithography, so that manufacturing easiness can be improved.

In the light source device X1, the light guide body 20 and the prism 30 are integrally configured. Therefore, the number of components of the light source device X1 can be reduced, and thus manufacturing efficiency can be improved.

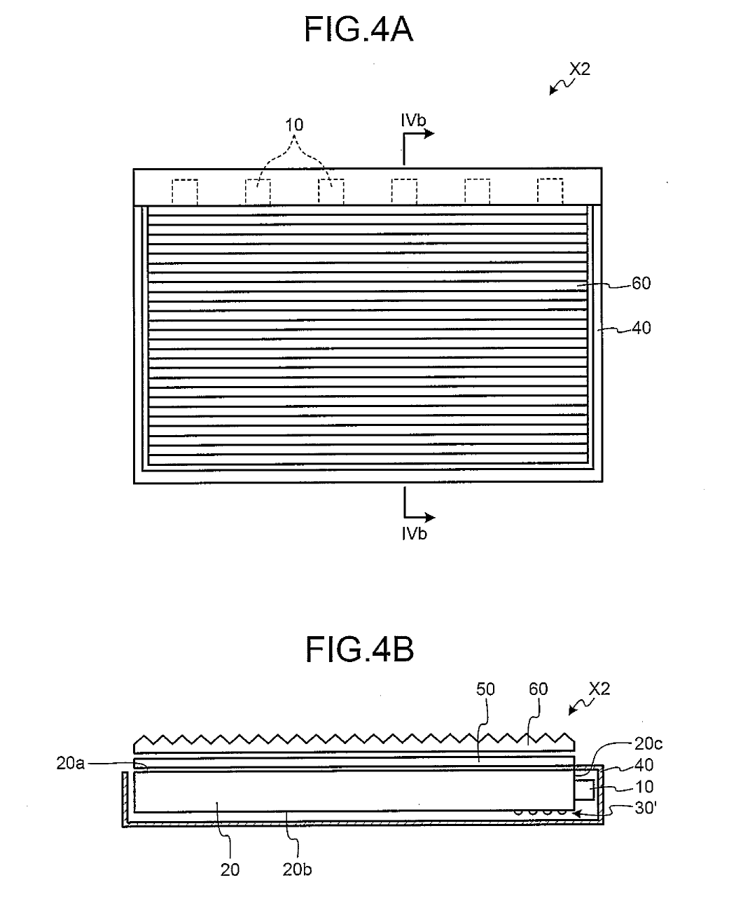

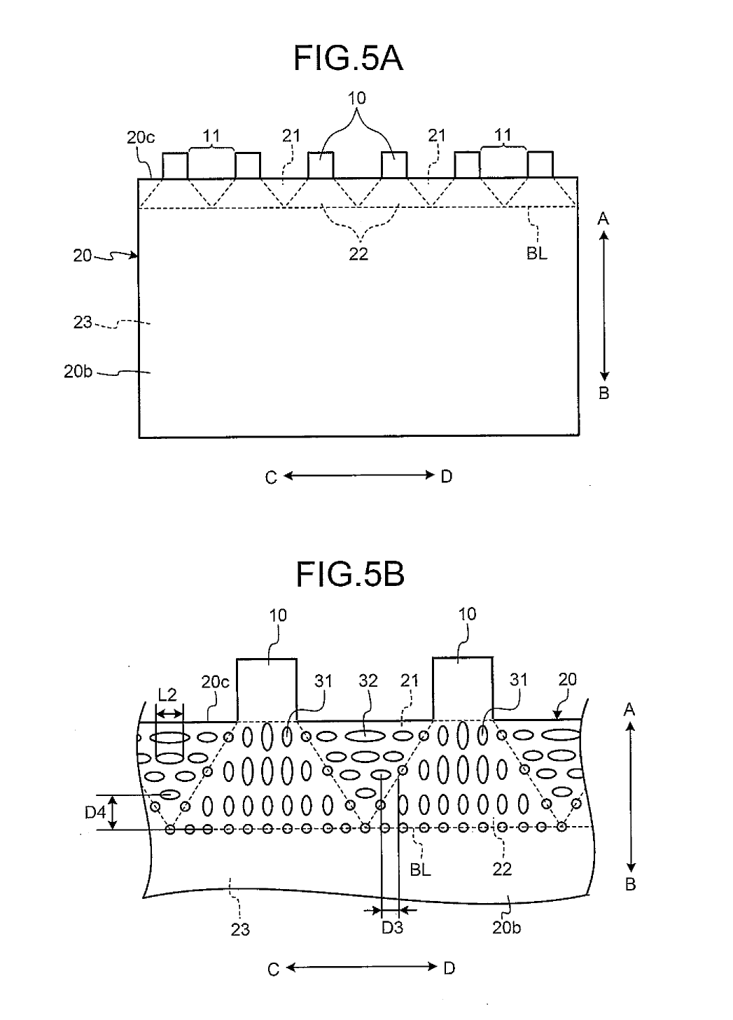

FIG. 4A is a plan view illustrating a schematic configuration of a light source device X2 according to a second embodiment of the invention. FIG. 4B is a cross-sectional view taken along the line IVb-IVb of FIG. 4A. FIG. 5A is a plan view illustrating a schematic configuration of the light sources 10, the light guide body 20, and a prism 30′. FIG. 5B is a plan view enlarging and illustrating essential portions of the light sources 10, the light guide body 20, and the prism 30′. In FIGS. 5A and 5B, the boundaries of the respective portions 21, 22, and 23 are illustrated by broken lines. The light source device X2 is different from the light source device X1 in that the prism 30′ is used instead of the prism 30. Excepting the difference, the configuration of the light source device X2 is the same as that of the light source device X1.

The prism 30′ performs a function of refracting and reflecting the incident light, and includes the first prism pattern 31 and a second prism pattern 32. In this embodiment, the prism 30′ is configured integrally with the light guide body 20.

The second prism pattern 32 is configured such that a component reflecting the light in the first portions 21 to the side of the third portion 23 is larger than a component reflecting the light in the first portions to the side of the second portions 22, and is positioned at the side of the bottom surface 20b of the light guide body 20 in the first portions 21. The second prism pattern 32 is configured to include a plurality of structure bodies each having an elliptical shape in plan view, which extends along a direction (direction of an arrow CD) substantially parallel to the facing surface 20c of the light guide body 20 facing the light sources 10. The second prism pattern 32 is configured such that the length L2 of the structure bodies each having an elliptical shape in plan view in a long axis direction is reduced so that the difference between the component reflecting the light in the first portions 21 to the side of the third portion 23 (in a direction of an arrow B) and the component reflecting the light in the first portions 21 to the side of the second portions 22 (in a direction of an arrow CD) decreases as the distance D3 (one example is illustrated in FIG. 5B) to the second portions 22 decreases. The second prism pattern 32 is configured such that the length L2 of the structure bodies each having an elliptical shape in plan view in a long axis direction is reduced so that the difference between the component reflecting the light in the first portions 21 to the side of the third portion 23 (in a direction of the arrow B) and the component reflecting the light to the side of the second portions 22 (in a direction of the arrow CD) decreases as the distance D4 (one example is illustrated in FIG. 5B) to the third portion 23 decreases.

In the light source device X2 according to this embodiment, the prism 30′ further includes the second prism pattern 32 configured such that a component reflecting the light in the first portions 21 to the side of the third portion 23 is larger than a component reflecting the light in the first portions 21 to the side of the second portions 22. Therefore, in the light source device X2, it is not required to distribute light in low intensity distribution areas with relatively low luminance to high intensity distribution areas with relatively high luminance, so that nonuniformity of the luminance due to existence of the non-light-emitting portions 11 between the light sources 10 can be prevented from increasing.

In the light source device X2, the second prism pattern 32 is configured such that the difference between the component reflecting the light in the first portions 21 to the side of the third portion 23 and the component reflecting the light to the side of the second portions 22 decreases as the distance D3 to the second portions 22 decreases. Therefore, in the light source device X2, the boundary between the first portions 21 and the second portions 22 can be hardly viewed.

In the light source device X2, the second prism pattern 32 is configured such that the difference between the component reflecting the light in the first portions 21 to the side of the third portion 23 and the component reflecting the light to the side of the second portions 22 decreases as the distance D4 to the third portion 23 decreases. Therefore, in the light source device X2, the boundary between the first portions 21 and the third portion 23 can be hardly viewed.

In the light source device X2, the second prism pattern 32 is configured to include the structure bodies each having an elliptical shape in plan view, which extends along a direction (direction of an arrow CD) substantially parallel to the facing surface 20c of the light guide body 20 facing the light sources 10. Therefore, in the light source device X2, the second prism pattern 32 can be manufactured with a mold and a stamper disposed in the mold manufactured using photolithography, so that manufacturing easiness can be improved.

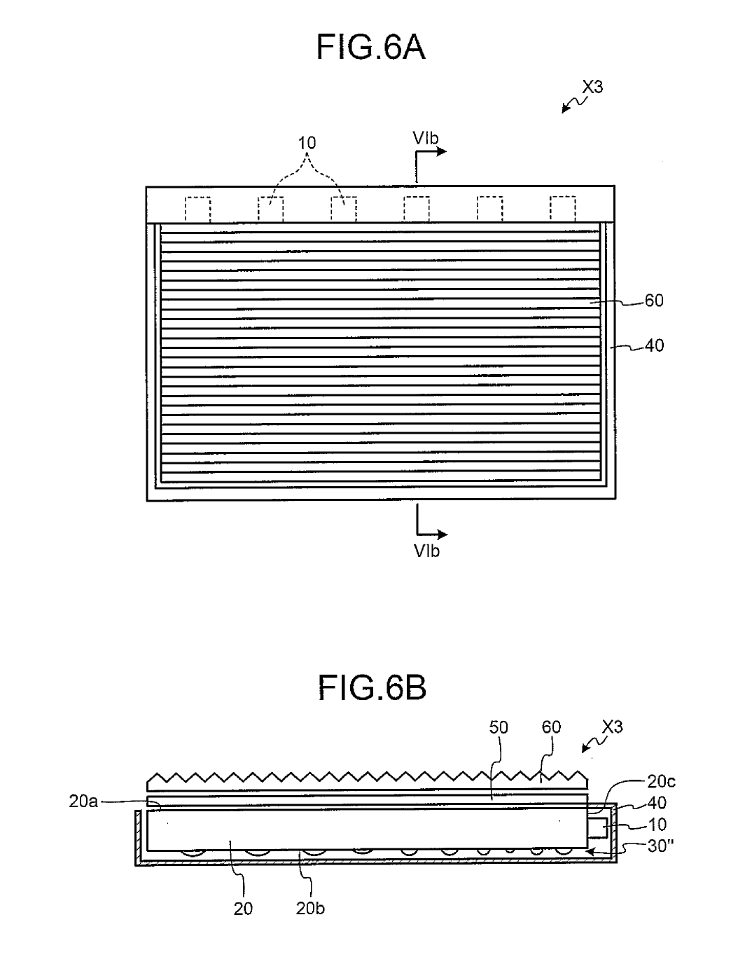

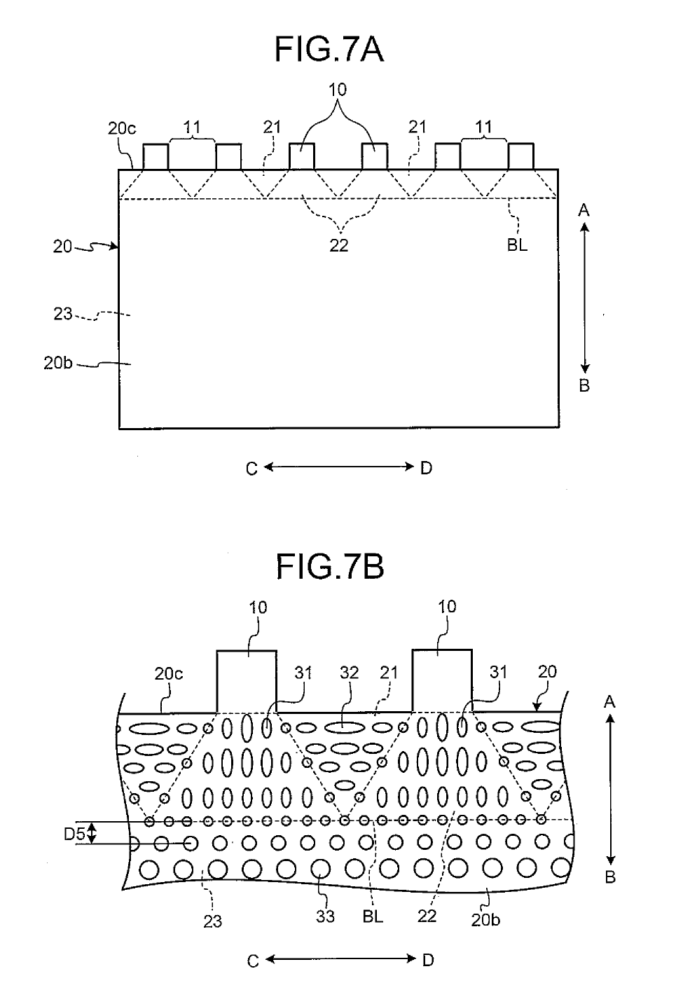

FIG. 6A is a plan view illustrating a schematic configuration of a light source device X3 according to a third embodiment of the invention. FIG. 6B is a cross-sectional view taken along the line VIb-VIb of FIG. 6A. FIG. 7A is a plan view illustrating a schematic configuration of a plurality of light sources 10, the light guide body 20, and a prism 30″. FIG. 7B is a plan view enlarging and illustrating essential portions of the light sources 10, the light guide body 20, and the prism 30″. In FIGS. 7A and 7B, the boundaries of the respective portions 21, 22, and 23 are illustrated by broken lines. The light source device X3 is different from the light source device X2 in that the prism 30″ is used instead of the prism 30′. Excepting the difference, the configuration of the light source device X3 is the same as that of the light source device X2.

The prism 30″ performs a function of refracting and reflecting the incident light and includes the first prism pattern 31, the second prism pattern 32, and a third prism pattern 33. In this embodiment, the prism 30″ is configured integrally with the light guide body 20.

The third prism pattern 33 is configured to reflect the light in the third portion 23 substantially equally in all directions in plan view, and is positioned at the side of the bottom surface 20b of the light guide body 20 in the third portion 23. The third prism pattern 33 is configured to include a plurality of structure bodies each having a circular shape in plan view. The third prism pattern 33 is configured such that an area thereof in plan view increases continuously or in stages as the distance D5 (one example is illustrated in FIG. 7B) from the facing surface 20c of the light guide body 20 facing the light sources 10 increases.

In the light source device X3 according to this embodiment, the prism 30″ further includes the third prism pattern configured to reflect the light in the third portion 23 substantially equally in all directions in plan view. Therefore, in the light source device X3, the light in the second portions 23 can be efficiently emitted to the side of the light irradiation surface 20a of the light guide body 20, so that the luminance in the third portion 23 can be increased.

In the light source device X3, the third prism pattern 33 is configured to include the structure bodies each having a circular shape in plan view. Therefore, in the light source device X3, the third prism pattern 33 can be manufactured using a mold and a stamper disposed in the mold manufactured using photolithography, so that manufacturing easiness can be improved.

In the light source device X3, the third prism pattern 33 is configured such that an area in plan view increases continuously or in stages as the distance D5 from the facing surface 20c of the light guide body 20 facing the light sources 10 increases. Therefore, in the light source device X3, nonuniformity of the luminance due to the distance D5 from the facing surface 20c with respect to the light sources 10 in the third portion 23 can be prevented from increasing.

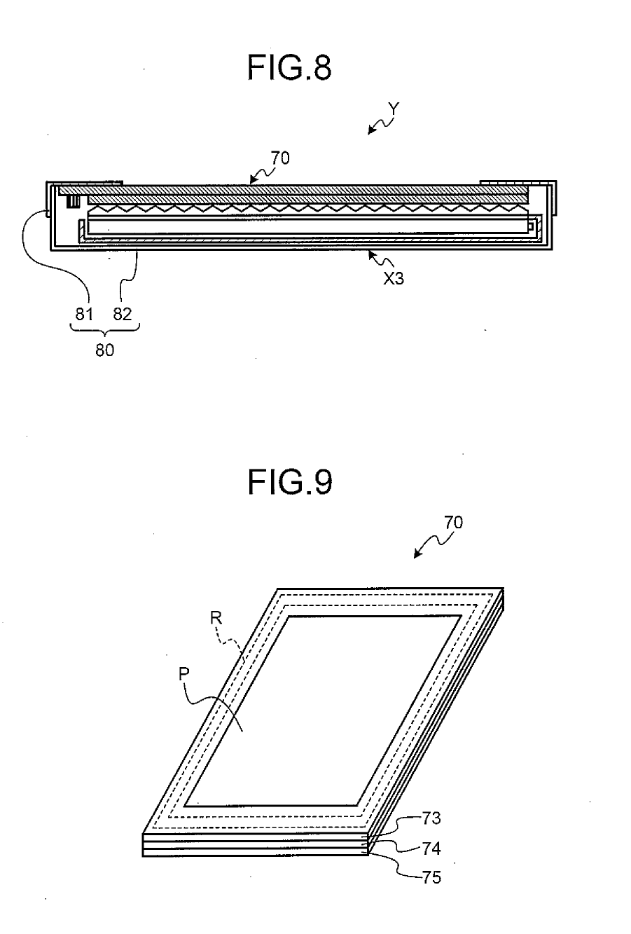

FIG. 8 is a cross-sectional view illustrating a schematic configuration of a display device Y provided with the light source device X3 according to the invention. The display device Y includes a liquid crystal display panel 70, the light source device X3, and a casing 80. The display device Y is described using the light source device X3, but the light source devices X1 or X2 can be used similarly.

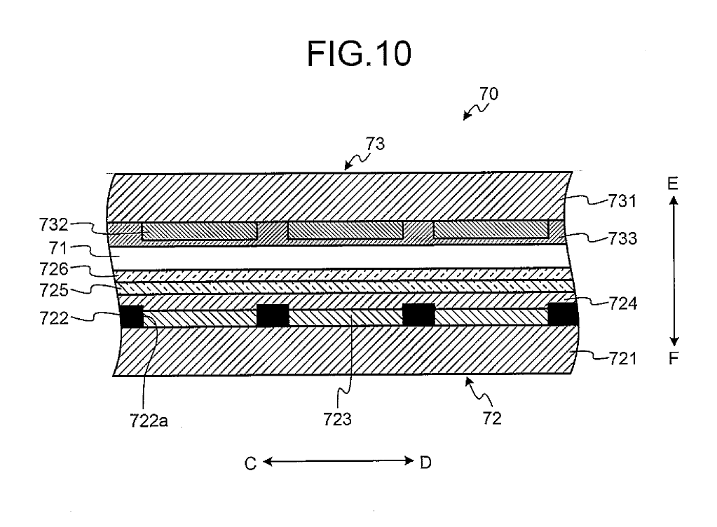

FIG. 9 is a perspective view illustrating a schematic configuration of the liquid crystal display panel 70 of the display device Y. FIG. 10 is a cross-sectional enlarged view illustrating essential portions of the liquid crystal display panel 70 illustrated in FIG. 9.

The liquid crystal display panel 70 includes a liquid crystal layer 71, a first base 72, a second base 73, and a sealing member 74. The liquid crystal layer 71 is interposed between the first base 72 and the second base 73, and the liquid crystal layer 71 is sealed by the sealing member 74. Accordingly, a display area P that includes a plurality of pixels to display an image is configured.

The liquid crystal layer 71 shows electrical, optical, mechanical, and magnetic anisotropy, and includes liquid crystal that has both of regularity of solid and fluidity of liquid. As the liquid crystal, nematic liquid crystal, cholesteric liquid crystal, and smectic liquid crystal may be exemplified. In the liquid crystal layer 71, a spacer (not illustrated) that is configured by a plurality of granular members may be interposed to maintain the thickness of the liquid crystal layer 71 constant.

The first base 72 includes a transparent base 721, a light shielding film 722, a color filter 723, a planarizing film 724, a transparent electrode 725, and an alignment film 726.

The transparent base 721 performs a function of supporting the light shielding film 722 and the color filter 723 as well as sealing the liquid crystal layer 71. The transparent base 721 can appropriately transmit light in a direction (for example, a direction of an arrow EF) crossing a major surface thereof. As a material of the transparent base 721, glass and light transmitting plastic may be exemplified.

The light shielding film 722 is a member that performs a function of shielding light (maintaining the amount of transmitted light to a predetermined value or less), and is formed on a top surface of the transparent base 721. The light shielding film 722 has through-holes 722a passing therethrough in a film thickness direction (in a direction of the arrow EF) so as to transmit the light. As a material of the light shielding film 722, a dye or a pigment of a color having a high light shielding property (for example, black), a resin (for example, acrylic resin) containing carbon added thereto, Cr, and chrome oxide may be exemplified.

The color filter 723 is configured by a member for selectively absorbing a predetermined wavelength among light incident to the color filter 723 and selectively transmiting only a predetermined wavelength, and may be formed by adding a dye or a pigment to an acrylic resin. As the color filter 723, for example, a red color filter (R) that selectively transmits a wavelength of red visible light, a green color filter (G) that selectively transmits a wavelength of green visible light, and a blue color filter (B) that selectively transmits a wavelength of blue visible light may be exemplified.

The planarizing film 724 performs a function of planarizing unevenness generated by arranging the color filter 723. As a material of the planarizing film 724, a transparent resin, such as an acrylic resin, may be exemplified.

The transparent electrode 725 performs a function of applying a predetermined voltage to a liquid crystal of the liquid crystal layer 71 positioned between a transparent electrode 732 of the second base 73 to be described below and the transparent electrode 725, and is configured to transmit light incident from one side to the other side thereof. The transparent electrode 725 performs a function of allowing a predetermined signal (image signal) to propagate therethrough and a plurality thereof is arranged to mainly extend in a direction of an arrow CD. As a material of the transparent electrode 725, a conductive member having a light transmitting property, such as indium tin oxide (ITO) and Tin Oxide, may be exemplified. In this case, the light transmitting property means a property for transmitting light with the light amount of a reference value or more.

The alignment film 726 performs a function of aligning liquid crystal molecules of the liquid crystal layer 71, which are macroscopically oriented in random directions (having low regularity), in a predetermined direction, and is formed on the transparent electrode 725. As a material of the alignment film 726, a polyimide resin may be exemplified.

The second base 73 includes a transparent base 731, the transparent electrode 732, and an alignment film 733.

The transparent base 731 performs a function of supporting the transparent electrode 732 and the alignment film 733 as well as sealing the liquid crystal layer 71.

The transparent base 731 can appropriately transmit light in a direction (for example, a direction of an arrow EF) crossing a major surface thereof. As a material of the transparent base 731, the same material as the material of the transparent base 721 may be exemplified.

The transparent electrode 732 performs a function of applying a predetermined voltage to a liquid crystal of the liquid crystal layer 71 positioned between the transparent electrode 725 of the first base 72 and the transparent electrode 732, and is configured to transmit light incident from one side to the other side thereof. The transparent electrodes 732 perform a function of allowing a signal (scanning signal), which controls a voltage application state (ON) or a voltage non-application state (OFF) with respect to the liquid crystal layer 71, to propagate therethrough and are arranged to mainly extend in a direction vertical to a plane of paper in FIG. 9. As a material of the transparent electrode 732, the same material as the material of the transparent electrode 725 may be exemplified.

The alignment film 733 performs a function of aligning liquid crystal molecules of the liquid crystal layer 71, which are macroscopically oriented in random directions (having low regularity), in a predetermined direction, and is formed on the transparent electrode 732. As a material of the alignment film 733, the same material as the material of the alignment film 726 may be exemplified.

The sealing member 74 performs a function of sealing the liquid crystal layer 71 between the first base 72 and the second base 73 as well as bonding the first base 72 and the second base 73 in a state where they are away from each other at a predetermined gap. As a material of the sealing member 74, an insulating resin and a sealing resin may be exemplified.

The light source device X3 is disposed to emit light from the light guide body 20 to the first base 72 of the liquid crystal display panel 70.

The casing 80 is for housing the liquid crystal display panel 70 and the light source device X3 and includes an upper casing 81 and a lower casing 82. As a material of the casing 80, a resin such as a polycarbonate resin and a metal such as a stainless (SUS) and aluminum may be exemplified.

Since the display device Y according to this embodiment includes the light source device X3, the same effect as that of the light source device X3 can be achieved. That is, in the display device Y, nonuniformity of the luminance due to existence of the non-light-emitting portions 11 between the light sources 10 can be prevented from increasing, and a device size can be decreased.

The specific embodiments of the invention have been described. However, the invention is not limited thereto and various changes can be made without departing from the spirit of the invention.

In the first portions 21 or the third portion 23 of the light guide body 20 in the light source devices X1 and X2, a prism pattern is not provided. However, the invention is not limited to the above configuration and a prism pattern for taking light from the light irradiation surface 20a may be provided.

The light source devices X1, X2, and X3 are configured such that the light is appropriately emitted through the light irradiation surface 20a by the reflection in the light guide body 20 or the reflection by the prism 30 and the reflection body 40. However, in order to more appropriately emit light through the light irradiation surface 20a, for example, the thickness of the light guide body 20 may be changed or particles may be dispersed in the light guide body 20.

In the light source devices X1, X2, and X3, the light guide body 20 and the prism 30 are integrally configured. However, the invention is not limited to the above configuration and the light guide body 20 and the prism 30 may be separately configured.

All of the prism patterns 31, 32, and 33 in the light source devices X1, X2, and X3 are positioned at the side of the bottom surface 20b of the light guide body 20, but may be positioned at the side of the top surface (light irradiation surface 20a) of the light guide body 20 or may be provided in the light guide body 20.

The first prism pattern 31 in the light source devices X1, X2, and X3 is configured such that the difference between the component reflecting the light in the second portions 22 to the side of the first portions 21 and the component reflecting the light in the second portions 22 to the side of the third portion 23 decreases as the distance D1 to the first portions 21 decreases. However, the invention is not limited to the above configuration. For example, the first prism pattern 31 may be configured such that the difference between the component reflecting the light in the second portions 22 to the side of the first portions 21 and the component reflecting the light in the second portions 22 to the side of the third portion 23 is substantially equalized, regardless of the distance D1 to the first portions 21.

The first prism pattern 31 in the light source devices X1, X2, and X3 is configured such that the difference between the component reflecting the light in the second portions 22 to the side of the first portions 21 and the component reflecting the light in the second portions 22 to the side of the third portion 23 decreases as the distance D2 to the third portion 23 decreases. However, the invention is not limited to the above configuration. For example, the first prism pattern 31 may be configured such that the difference between the component reflecting the light in the second portions 22 to the side of the first portions 21 and the component reflecitng the light in the second portions 22 to the side of the third portion 23 is substantially equalized, regardless of the distance D2 to the third portion 23.

Each of the prism patterns 31 and 32 in the light source devices X1, X2, and X3 has the structure bodies each having an elliptical shape in plan view, but the invention is not limited to the above configuration. For example, each of the prism patterns 31 and 32 may have structure bodies each having a rectangular shape in plan view.

Each of the prism patterns 31, 32, and 33 in the light source devices X1, X2, and X3 have the structure bodies. However, the invention is not limited thereto and each of the prism patterns 31, 32, and 33 may have only one structure body.

The second prism pattern 32 in the light source devices X2 and X3 is configured such that the difference between the component reflecting the light in the first portions 21 to the side of the third portion 23 and the component reflecting the light in the first portions 21 to the side of the second portions 22 decreases as the distance D3 to the second portions 22 decreases, but the invention is not limited to the above configuration. For example, the second prism pattern 32 may be configured such that the difference between the component reflecting the light in the first portions 21 to the side of the third portion 23 and the component reflecting the light in the first portions 21 to the side of the second portions 22 is substantially equalized, regardless of the distance D3 to the second portions 22.

The second prism pattern 32 in the light source devices X2 and X3 is configured such that the difference between the component reflecting the light in the first portions 21 to the side of the third portion 23 and the component reflecting the light in the first portions 21 to the side of the second portions 22 decreases as the distance D4 to the third portion 23 decreases, but the invention is not limited to the above configuration. For example, the second prism pattern 32 may be configured such that the difference between the component reflecting the light in the first portions 21 to the side of the third portion 23 and the component reflecting the light in the first portions 21 to the side of the second portions 22 is substantially equalized, regardless of the distance D4 to the third portion 23.

The third prism pattern 33 in the light source device X3 has the structure bodies each having a circular shape in plan view, but the invention is not limited to the above configuration. For example, the third prism pattern 33 may have structure bodies each having a regular polygon shape in plan view. In this case, the polygon means a polygon that has at least (2n+2) (n is a natural number) angular portions.

The third prism pattern 33 in the light source device X3 is configured such that the area in plan view increases continuously or in stages as the distance D5 from the facing surface 20c of the light guide body 20 increases, but the invention is not limited to the above configuration. For example, the third prism pattern 33 may be configured such that the area in plan view is substantially equalized, regardless of the distance D5 from the facing surface 20c of the light guide body 20.

The third prism pattern 33 in the light source device X3 is configured such that the area in plan view increases continuously or in stages as the distance D5 from the facing surface 20c of the light guide body 20 increases. However, the arrangement density of the each of the structure bodies may be changed, instead of changing the size of the area in plan view.

The display device Y is not limited to the liquid crystal display device including the liquid crystal display panel 70. For example, any display device that does not have a self-emitting light source may be used.

In the light source device according to the invention, the first structure bodies each having an elliptical shape or a rectangular shape in plan view are disposed such that the longitudinal direction of the first structure bodies is extended along a direction substantially vertical to the facing surface of the light guide body facing the light sources corresponding to the light sources. That is, in the light source device, the light of the high intensity distribution areas with relatively high luminance can be distributed to the low intensity distribution areas with relatively low luminance. For this reason, in the light source device, the luminance in the low intensity distribution areas can be increased while the luminance in the high intensity distribution areas can be prevented from excessively increasing. Accordingly, in the light source device, nonuniformity of the luminance due to existence of the non-light-emitting portions between the light sources can be prevented from increasing. In addition, the light source device can use the areas of the second portions corresponding to the high intensity distribution areas and the first portions corresponding to the low intensity distribution areas as the display area. Therefore, even in the configuration where the light emitted from the light sources is made to be incident on the light guide body, undesirable dead spaces can be prevented from being generated, and thus a device size can be decreased.

In the light source device according to the invention, the prism may further include the second structure bodies each having an elliptical shape or a rectangular shape in plan view, and the second structure bodies are disposed to correspond to the light sources such that the longitudinal direction of the second structure bodies is extended along a direction substantially parallel to the facing surface of the light guide body facing the light sources. In this case, it is not required to distribute the light in the low intensity distribution areas with relatively low luminance to the high intensity distribution areas with relatively high luminance. Accordingly, nonuniformity of the luminance due to existence of the non-light-emitting portions between the light sources can be prevented from increasing. In particular, when the structure bodies each having an elliptical shape in plan view are adopted as the second structure bodies, the prism can be manufactured using a mold and a stamper disposed in the mold manufactured using photolithography, so that manufacturing easiness can be improved.

In the light source device according to the invention, the prism may further include the third structure bodies each having a circular shape in plan view, and the third structures may be disposed outside of the arrangement area of the first structure bodies. In this case, light that reaches outside of the arrangement area of the first structures can be efficiently emitted to the side of the major surface of the light guide body, so that the luminance in the area outside of the arrangement area of the first structure bodies can be increased.

In the light source device according to the invention, the area of the third structures in plan view may increase as the distance from the facing surface with the light sources in the light guide body increases. In this case, the nonuniformity of the luminance due to the distance from the facing surface to the light sources in the area outside of the arrangement area of the first structures can be prevented from increasing.

In the light source device according to the invention, wherein the arrangement density of the third structure bodies increases when the distance from the facing surface with the light sources in the light guide body increases, the nonuniformity of the luminance due to the distance from the facing surface to the light sources in the area outside of the arrangement area of the first structures can be prevented from increasing.

1. A light source device provided with a plurality of light sources, a light guide body disposed to face the light sources, and a prism to reflect light from the light guide body, wherein,
in the light guide body, an area where light having luminance equal to or higher than a reference value is incident from each of the light sources is defined as a high intensity distribution area, and an area where light having luminance lower than the reference value is incident is defined as a low intensity distribution area,
the light guide body includes:
a first portion where a low intensity distribution area defined by one of the light sources and another low intensity distribution area defined by another one of the light sources adjacent to the one of the light sources overlap each other;
a second portion that is a portion of the high intensity distribution area, which is positioned closer to the one of the light sources than a boundary line connecting boundaries, each of the boundaries being between the first portion and an overlapping portion where a high intensity distribution area defined by the one of the light sources overlaps with high intensity distribution areas defined by the light sources adjacent to the one of the light sources;
and a third portion that is a portion of the high intensity distribution areas other than the second portion, and
the prism comprises a first prism pattern in which a component reflecting the light in the second portion to a side of the first portion is larger than a component reflecting the light in the second portion to a side of the third portion.

2. The light source device of claim 1, wherein, as a distance between the first prism pattern and the first portion decreases, a difference between the component reflecting the light in the second portion to the side of the first portion and the component reflecting the light in the second portion to the side of the third portion decreases.

3. The light source device of claim 1, wherein, as a distance between the first prism pattern and the third portion decreases, a difference between the component reflecting the light in the second portion to the side of the first portion and the component reflecting the light in the second portion to the side of the third portion decreases.

4. The light source device of claim 1, wherein the prism further comprises a second prism pattern in which a component reflecting the light in the first portion to the side of the third portion is greater than a component reflecting the light in the first portion to the side of the second portion.

5. The light source device of claim 4, wherein, as a distance between the second prism pattern and the second portion decreases, a difference between the component reflecting the light in the first portion to the side of the third portion and the component reflecting the light in the first portion to the side of the second portion decreases.

6. The light source device of claim 4, wherein, as a distance between the second prism pattern and the third portion decreases, a difference between the component reflecting the light in the first portion to the side of the third portion and the component reflecting the light in the first portion to the side of the second portion decreases.

7. The light source device of claim 1, wherein the prism further comprises a third prism pattern reflecting light in the third portion substantially equally in all directions in plan view.

8. The light source device of claim 7, wherein an arrangement density of the third prism pattern increases as a distance from a surface facing the light sources in the light guide body increases.

9. The light source device of claim 1, wherein the light guide body and the prism are integrated with each other.

10. A light source device, comprising:
a light source;
a light guide plate that includes a first major surface, a second major surface, and a facing surface facing the light source, and emits light from the light source by the first major surface; and
a prism that is positioned at a side of the second major surface of the light guide plate, and reflects light incident on the light guide plate, wherein
the prism has a first structure body that is positioned in a front area of the light source in plan view, and
the first structure body has a length in a direction orthogonal to the facing surface larger than a length in a direction parallel to the facing surface.

11. The light source device of claim 10, wherein
the light source has a plurality of light sources disposed at a predetermined interval,
the prism further has a second structure body that is positioned in an area between the adjacent front areas, and
the second structure body has a length in the direction parallel to the facing surface larger than a length in the direction orthogonal to the facing surface.

12. The light source device of claim 10, wherein
the prism further comprises a third structure body having a circular shape in plan view, and
the third structure body is disposed outside of an arrangement area of the first structure body.

13. The light source device of claim 12, wherein an arrangement density of the third structure body increases as the distance from a surface facing the light sources in the light guide plate increases.

14. The light source device of claim 10, wherein the light guide body and the prism are integrated with each other.

15. A display device comprising the light source device of claim 1.
